(19) United States
(12) Patent Application Publication
(10) Pub. No.: US 2017/0361633 A1
(43) Pub. Date: Dec. 21, 2017

(54) Printing Device Capable of Realizing Combined Jet Printing

(71) Applicant: Shenzhen Textalk Graphic Technology Co., Ltd., Shenzhen City (CN)

(72) Inventors: Shoubin Wang, Shenzhen City (CN); Wenhong Wang, Shenzhen City (CN); Hui Zhang, Shenzhen City (CN)

(21) Appl. No.: 15/229,343

(22) Filed: Aug. 5, 2016

(30) Foreign Application Priority Data
Jun. 16, 2016 (CN) 201610428232.6

(51) Int. Cl. B41J 25/00

(52) U.S. Cl. CPC B41J 25/001

(57) ABSTRACT

The invention relates to the field of printing and dyeing and discloses a printing device capable of realizing combined jet printing including a cross beam, inkjet devices and a power device, wherein at least two inkjet devices are provided and installed on the cross beam as well as can be driven by the power device to move relative to the cross beam, the inkjet devices can move relative to the cross beam in a separate manner and can implement the inkjet action separately. According to the invention, the jet printing of ground color and pattern can be realized in the equipment by arranging at least two inkjet devices capable of moving in a separate manner in one cross beam, which is conducive to reducing the enterprise cost; meanwhile, transfer links of a medium among different equipments are avoided to improve the production efficiency.

### FIELD OF THE INVENTION

The present invention relates to the field of printing and dyeing, and more particular, to an inkjet device.

### BACKGROUND OF THE INVENTION

Inkjet printing is a technology that forms patterns in a medium (such as cloth) via jet printing, which is widely applied in the field of clothes processing. The equipment realizing the inkjet printing is called as a printing machine. The printing machine is generally provided with an ink carriage or an inkjet head as the output end. The patterns are subject to jet printing by moving the ink carriage or inkjet head.

With respect to the medium darker in color, it needs to be subject to jet printing with one layer of light-colored underpainting in advance, and then is subject to the pattern on the underpainting, which can avoid the color of the medium from covering up the pattern. In the prior art, the medium is firstly placed on a screen printing machine to print the underpainting and then on an inkjet printing machine for the jet printing of the pattern as a rule. However, this mode needs to purchase two sets of equipment including the screen printing machine and the inkjet printing machine, which greatly increase the enterprise cost. Meanwhile, the medium needs to be transferred among different equipments, which limits the increase in production efficiency.

### SUMMARY OF THE INVENTION

In order to overcome the disadvantages of the prior art, the invention provides a printing device capable of realizing combined jet printing, which is configured to solve the problem that the quick jet printing of underpainting and pattern fails to be realized in one set of equipment in the prior art.

In order to solve the technical problems, the invention employs the technical solutions as follows:

A printing device capable of realizing combined jet printing comprises a cross beam, inkjet devices and a power device, wherein at least two inkjet devices are provided and installed on the cross beam as well as can be driven by the power device to move relative to the cross beam, the inkjet devices can move relative to the cross beam in a separate manner and can implement the inkjet action separately.

As a further improved mode of the foregoing solution, the inkjet devices are located at the side wall or the bottom of the cross beam.

As a further improved mode of the foregoing solution, the inkjet devices are located at both sides of the cross beam.

As a further improved mode of the foregoing solution, comprising a distance measuring device for measuring the position of the inkjet device relative to the cross beam.

As a further improved mode of the foregoing solution, the distance measuring device is a magnetic grating or an optical grating arranged on the cross beam and parallel to the length direction of the cross beam.

As a further improved mode of the foregoing solution, the power device is a linear motor, including a stator arranged along the length direction of the cross beam and rotors with the number equal to that of the inkjet devices, wherein the rotors are connected with the corresponding inkjet devices respectively.

As a further improved mode of the foregoing solution, the power device comprises synchronous belt modules with the number corresponding to that of the inkjet devices, each synchronous belt module comprises a drive wheel and a driven wheel arranged on the cross beam, and synchronous belts wound around the drive wheel and the driven wheel, and the inkjet devices are connected with the corresponding synchronous belts respectively.

As a further improved mode of the foregoing solution, the power device comprises screw rod modules with the number corresponding to that of the inkjet devices, each screw rod module comprises a screw rod arranged on the cross beam and parallel to the length direction of the cross beam and a nut seat screwed with the screw rod, and the inkjet devices are connected with the corresponding nut seats respectively.

The invention has the advantageous effects that:

The jet printing of underpainting and pattern can be realized in the equipment by arranging at least two inkjet devices capable of moving in a separate manner on one cross beam, without needing to purchase a screen printing machine, an inkjet printing machine and other various sets of equipment, which is conducive to reducing the enterprise cost; meanwhile, transfer links of a medium among different equipments are avoided to improve the production efficiency; in addition, various inkjet devices are arranged in one cross beam, which can effectively reduce both the overall volume and the space of the device.

### BRIEF DESCRIPTION OF THE DRAWINGS

The present invention will be further described in details hereunder with reference to the drawings and the embodiments.

FIG. 1 is a three-dimensional schematic diagram of the first embodiment of the present invention;

FIG. 2 is a breakdown schematic diagram of the first embodiment of the present invention; and

FIG. 3 is a breakdown schematic diagram of one embodiment of an inkjet device of the present invention.

### DETAILED DESCRIPTION OF THE EMBODIMENTS

The conception, specific structure and generated technical effect of the invention will be described clearly and completely with reference to the embodiments and the drawings hereunder, so as to fully understand the object, solution and effect of the invention. It should be noted that the embodiments in the application and the features in the embodiment can be mutually combined under the condition without conflict.

It should be noted that unless otherwise specified herein, when a certain feature is called as “fixed” or “connected” to the other feature, it can not only be directly fixed or connected to the other feature, but also indirectly fixed or connected to the other feature. In addition, the terms like up, down, left and right used in the invention are merely relative to the mutual position relation of various components of the invention in the drawings.

In addition, unless otherwise defined, the meanings of all technologies and scientific terms used herein are the same as those generally understood by those skilled in the art. The terms used herein are merely for describing the specific embodiment, but not intended to limit the invention. The terms “and/or” used herein comprise one or any combination of more related listed items.

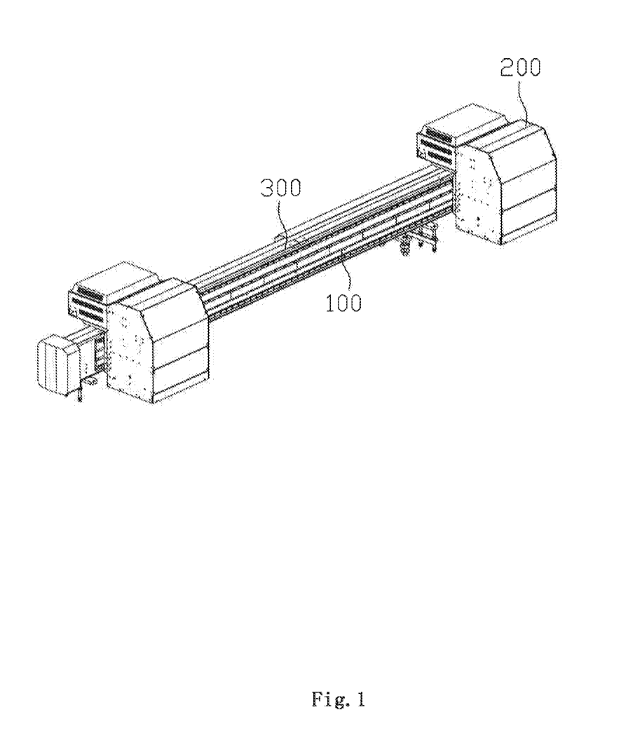

Referring to FIG. 1, a three-dimensional schematic diagram of the first embodiment of the invention is illustrated. The printing device comprises a cross beam 100 and an inkjet device 200.

The inkjet device 200 can employ the routine technique, such as an inkjet carriage and the like. The cross beam 100 is at least provided with two inkjet devices 200. Taking two inkjet devices for example, two inkjet devices 200 can move along the length direction of the cross beam 100 under the drive by the corresponding power device. A medium to be subject to jet printing is distributed along the length direction of the cross beam 100 as well. Preferably, the distance between the adjacent media is equal. The inkjet device is in an equidistance motion, which can ensure that the inkjet device is aligned with the media.

Generally, the existing printing machine is merely provided with one inkjet device. However, single inkjet device is hard to meet the requirements of quick jet printing. Therefore, people go on proposing an improved solution, providing two inkjet devices which can move synchronously and can be configured for the inkjet printing of different colors respectively. Two inkjet devices coordinate together to complete the printing of the media, that is to say, two inkjet devices move to one certain medium to be printed, wherein one of the inkjet devices firstly prints one color and then the other thereof prints the other color; after printing completely, two inkjet devices move synchronously to the other medium to be printed once again and the foregoing actions are repeated. But this mode also has the following defects: the time as required for different jet printing steps is inconsistent. For example, the jet printing speed for the first time is usually quicker than the subsequent jet printing speed. In this way, it also needs to wait for completing the inkjet printing by the subsequent inkjet device even if the first inkjet device has completed the current jet printing, which affects the production efficiency seriously. Based on this, the invention further proposes an improved mode, that is to say, the inkjet device can move separately. The separate movement comprises both the separate of the inkjet action and that of the movement of the inkjet device with respect to the cross beam. With respect to the solution of synchronous movement of the existing inkjet device and the separate inkjet, the inkjet device in the invention can both implement the inkjet action separately and move relative to the cross beam separately. Thus, the foregoing problem of overlong waiting time can be solved, which is conducive to enhancing the production efficiency; meanwhile, the inkjet device and the media can be allowed to place in multiple manners, but not intended to be limited within linear arrangement.

The quick jet printing of the media can be realized by supplying dye (such as white ink) forming the underpainting for one inkjet device 200 and supplying the dye (such as color ink) forming the pattern for the other inkjet device. For example, two working positions for carrying with the media can be arranged below the cross beam. Two inkjet devices 200 move from one end of the cross beam to the other end thereof. The inkjet device (hereinafter referred as the first inkjet device) located at the front performs the jet printing for the medium on the first working position to form the underpainting, while in the process, the inkjet device 200 (hereinafter referred to as the second inkjet device) located at the rear remains stationary. After completing the jet printing of the underpainting for the first time, the first inkjet device continuously moves along the cross beam 100 to the second working position for the continuous jet printing of the underpainting; while the second inkjet device moves to the first working position for the jet printing of the medium on the first working position to form the pattern. After completing the jet printing of the underpainting for the second time, the first inkjet device continuously moves forward to enter the standby position; while the second inkjet device moves to the second working position for the jet printing of the patter. After completing the jet printing, two inkjet devices move backward to the initial position to wait for the next action. It is assumed that the time as required for the jet printing of the underpainting is 10 s and the time as required for the jet printing of the pattern is 20 s. There are two media to be subject to jet printing. For the jet printing of the first medium, the time in the existing solution is 30 s which is equal to that as required in the invention. For the printing of the second medium, the total time of jet printing is 60 s, i.e., the adding time as required for all actions as the next jet printing action cannot be taken until the previous jet printing action is completed in the existing solution. For the invention, the jet printing of the underpainting for the second medium can be implemented immediately after completing that of the underpainting for the first medium. The jet printing of the pattern of the first medium is completed exactly when the jet printing of the underpainting of the second medium is completed (spending 20 s), and the jet printing of the pattern of the second medium can be implemented immediately at this time. The total time is 50 s when completing the jet printing of the underpainting of the second medium, that is to say, the total time in the invention is merely determined by the actions wasting more time. With respect to the mode that the total time is determined by various actions together in the existing solution, the work efficiency is remarkably enhanced. In addition, the jet printing of the underpainting and pattern can also be realized in one equipment in the invention, without needing to purchase a screen printing machine, an inkjet printing machine and other various sets of equipment, which is conducive to reducing the enterprise cost; meanwhile, transfer links of a medium among different equipments are avoided to improve the production efficiency; in addition, various inkjet devices are arranged in one cross beam, which can efficiently reduce both the overall volume and the space of the device.

There are two inkjet devices 200 in the foregoing embodiment. The number of the inkjet devices can be changed in other embodiments, such as three or more, including one inkjet device for the jet printing of the underpainting plus with various inkjet devices for the jet printing of different colors. The number of the inkjet devices 200 can be relatively equal to or different from that of the media in the invention.

The inkjet devices 200 in the embodiment are preferably arranged on the side wall of the cross beam 100 and located at same side of the cross beam, which occupies a smaller space. Obviously, there are various positions of the inkjet devices 200 relative to the cross beam, for example, the inkjet devices can be suspended at the bottom portion of the cross beam 100, and the inkjet devices 200 can also be arranged at both sides of the cross beam 100.

In addition, the cross beam 100 is further provided with a distance measuring device 300. The distance measuring device 300 can employ routine techniques like magnetic grating or optical grating. The embodiment employs the magnetic grating, which is used for measuring the position of the inkjet device 200 relative to the cross beam 100. On one hand, the coordination with the working position can be realized; on the other hand, the collision between the inkjet devices 200 can be avoided.

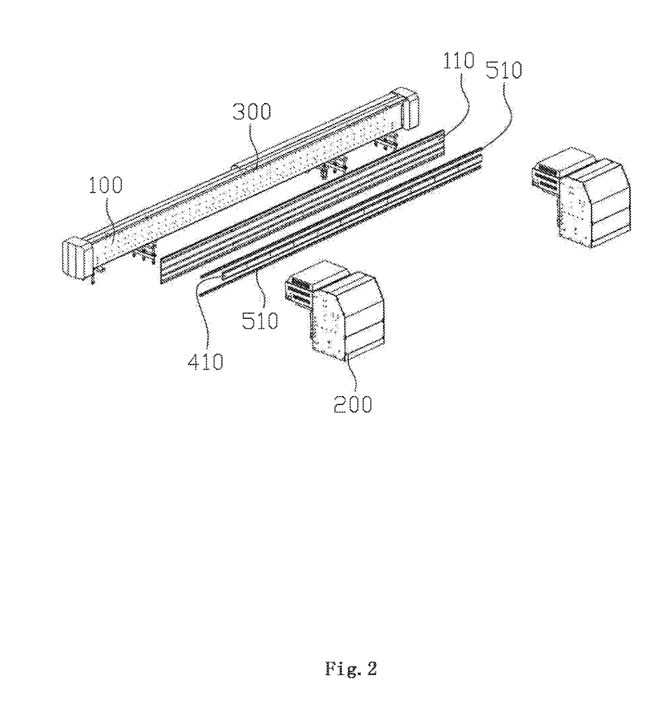

Referring to FIG. 2, a breakdown schematic diagram of the first embodiment of the present invention is illustrated. A power device is arranged between the cross beam 100 and the inkjet device 200. As one optimal embodiment of the power device, it is a linear motor, which specifically comprises a stator 410 arranged along the length direction of the cross beam (in figure, the stator 410 is arranged in the side wall at one side of the cross beam 100; but if the inkjet devices 200 are located at the bottom portion of the cross beam 100 or both sides of the cross beam 100 respectively, the installation position of the stator 410 also need to be adjusted), and rotors in the number correspondingly equal to that of the inkjet devices 200 (without illustrated in figure). The rotors are connected with the corresponding inkjet devices 200 respectively. The separate movements of various inkjet devices 200 can be realized by separate power supply or power failure for the rotors. In the prior art, the use of the linear motor is that one stator is corresponding to one rotor. If various devices needed to drive to move, the conventional method is to provide for various linear motors. The embodiment breaks through the dead zone of the existing means. One set of linear motor can drive various inkjet carriages to move by transforming the common linear motor, which minimizes the volume of the device, greatly reduces the cost, does not need to provide a complicated connection structure, and reduces the difficulty of production and installation.

Further, the embodiment is provided with horizontal guide rails 510. Two horizontal guide rails 510 are optimized to be arranged at the upper end and the lower end of the stator 410 and parallel to the stator 410. The inkjet device 200 is provided with a horizontal sliding block (without illustrated in figure). The inkjet device 200 can slide relative to the horizontal guide rail 510 via the horizontal sliding block.

To be specific, the stator 410 and the horizontal guide rail 510 are connected with the cross beam 100 via an installation plate 110. The installation plate 100 is fixed on the side wall of the cross beam, and the outer surface thereof is provided with three horizontal installation slots. The stator 410 and the horizontal guide rails 510 are embedded into the corresponding installation slots respectively and locked by fasteners.

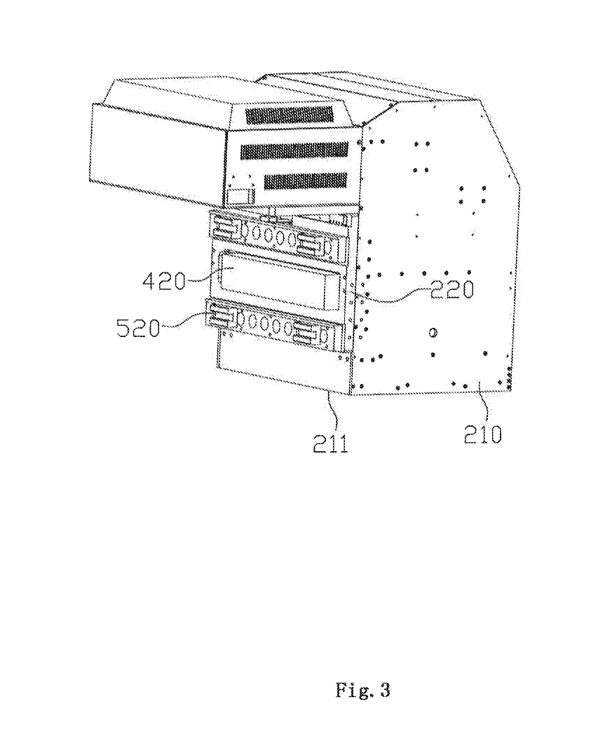

Referring to FIG. 3, a three-dimensional schematic diagram of one embodiment of the inkjet device 200 of the invention is illustrated. The inkjet device 200 comprises a housing 210 and a connecting plate 220. The connecting plate 220 is located outside the side wall 211 of the housing 210 and is provided with a rotor 420 and a horizontal sliding block 520.

The foregoing linear motor is served as the preferred exemplary embodiment of the invention. Of course, the power device can also employ the other modes, such as synchronous belt modules in the number corresponding to that of the inkjet devices 200. The synchronous belt module comprises a drive wheel and a driven wheel arranged on the cross beam, as well as synchronous belts wound around the drive wheel and the driven wheel. The inkjet devices are connected with the corresponding synchronous belts respectively.

In addition, a screw rod can also be employed for driving, that is to say, the power device comprises screw rod modules with the number corresponding to that of the inkjet devices, the screw rod module comprises the screw rod arranged on the cross beam and parallel to the length direction of the cross beam and a nut seat screwed with the screw rod, and the inkjet device is connected with the corresponding nut respectively.

The power device can also be the other conventional means, which will not be elaborated herein.

The above is the specific description for the preferred embodiment of the invention, but the invention creation is not intended to limit the foregoing embodiments. Various identical transformations or replacements can further be made by those skilled in the art without departing from the spirit of the invention shall all fall within the scope limited by the claims.

1. A printing device capable of realizing combined jet printing, comprising a cross beam, inkjet devices and a power device, wherein at least two inkjet devices are provided and installed on the cross beam as well as can be driven by the power device to move relative to the cross beam, the inkjet devices can move relative to the cross beam in a separate manner and can implement the inkjet action separately
wherein the inkjet devices are located at the side wall or the bottom of the cross beam, wherein the inkjet devices comprise a housing and a connecting plate, wherein the connecting plate is located outside the side wall of the housing, and is provided with a horizontal sliding block; and
wherein the power device comprises a stator arranged along a length direction of the cross beam and rotors with the number equal to that of the inkjet devices, wherein the rotors are connected with the corresponding inkjet devices respectively, wherein the stator and a horizontal guide rail are connected with the cross beam via an installation plate, wherein the installation plate is fixed on the side, wall of the cross beam.

2. (canceled)

3. The printing device capable of realizing combined jet printing according to claim 1, wherein the inkjet devices are located at the same side of the cross beam.

4. The printing device capable of realizing combined jet printing according to claim 1, comprising a distance measuring device for measuring the position of the inkjet device relative to the cross beam.

5. The printing device capable of realizing combined jet printing according to claim 4, wherein the distance measuring device is a magnetic grating or an optical grating arranged on the cross beam and parallel to the length direction of the cross beam.

6-8. (canceled)
